(19) United States
(12) Patent Application Publication
(10) Pub. No.: US 2026/0071952 A1
(43) Pub. Date: Mar. 12, 2026

(54) SPECTRAL SENSOR SYSTEM FOR ANALYZING A SAMPLE IN A HARSH ENVIRONMENT AND METHOD OF ANALYSING A SAMPLE IN A HARSH ENVIRONMENT

(71) Applicant: MANTISPECTRA B.V., Eindhoven (NL)

(72) Inventors: Maurangelo Petruzzella, Eindhoven (NL); Kaylee Doranne Hakkel, Eindhoven (NL); Fang Ou, Eindhoven (NL); Petar Ševo, Eindhoven (NL); Francesco Maria Pagliano, Eindhoven (NL)

(21) Appl. No.: 19/106,151

(22) PCT Filed: Aug. 28, 2023
(86) PCT No.: PCT/NL2023/050438

§ 371 Date: Feb. 24, 2025

(30) Foreign Application Priority Data
Aug. 26, 2022 (NL) 2032862

(51) Int. Cl. G01N 21/25; G01N 21/359

(52) U.S. Cl. CPC G01N 21/255; G01N 21/359; G01N 2201/022

(57) ABSTRACT

A spectral sensor system for analysing a sample in a harsh environment comprising: an illumination unit configured for emitting light to the sample at, at least two wavelengths; an optical detector unit comprising a plurality of detector elements, wherein each respective detector element of the plurality of detector elements is configured for detecting one or more respectively different wavelength regions, wherein the optical detector unit is configured for detecting a spectrum of the light, the spectrum having non-zero components at the at least two wavelengths, after the light has interacted with the sample; and at least one layer arranged between the sample and the optical detector unit; wherein the at least one layer is at least partially optically transparent to the detected spectrum of the light; and wherein the at least one layer is sufficiently resistant to the harsh environment.

### TECHNICAL FIELD

The present disclosure generally relates to optical sensing. Particular embodiments relate to a spectral sensor system for, and a method of, analysing a sample in a harsh environment.

### BACKGROUND

Spectral sensors have been used for decades in many laboratories worldwide for identifying and quantifying chemical compositions of materials based on their emission, reflection or transmission spectra. Nowadays, they are an important tool in industrial and agricultural applications for performing spectral analysis on samples. Also in the consumers' market, for example for monitoring food quality, as well as in the health care market, there is a growing need for such tools.

Spectral sensor systems make use of the optical interaction between light and a (test) sample of a material. The interaction can be used to identify the chemical composition of the sample or to measure its physical properties. The sensor system generates, based on the measured reflected, transmitted, emitted or scattered light, a spectral fingerprint by which materials composing the sample can be quantified, identified or classified, i.e. by comparing the measured spectral fingerprint with the fingerprint of known, reference fingerprints. If the measured fingerprint corresponds with that of a reference fingerprint, it may be concluded that the measured sample contains the material of the reference with a corresponding fingerprint.

Miniaturized near-infrared (NIR) spectral sensors provide accurate results for a broad range of classification and quantification problems. In-line measurements are required for process control applications for example along a production line. This is required to avoid having to send samples to dedicated laboratories or having to remove samples or disturb the process. More importantly, these systems provide real-time information on the process which enables direct control in production and tuning of processing parameters. With the advent of new generations of spectral engines with reduced footprint, power consumption and cost, new applications are possible even in the consumer domain, in particular when these sensors are integrated in existing devices, such as food processing machines, refrigerators, smart toilets, washing machines, dryers, cleaning robots and vacuum cleaners. This provides new dimensions and insights to the consumer, simplifying their life and or routines, enabling them to check authenticity and traceability of materials, and opening a new paradigm to quality analysis in smart houses.

### SUMMARY

Accordingly, there is a need for sensor technology for real-time in-line measurements of material properties inside a system.

There is provided in a first aspect according to the present disclosure a spectral sensor system for analysing a sample in a harsh environment, the system comprising:
an illumination unit configured for emitting light to the sample at at least two wavelengths;
an optical detector unit comprising a plurality of detector elements, wherein each respective detector element of the plurality of detector elements is configured for detecting one or more respectively different wavelength regions, wherein the optical detector unit is configured for detecting a spectrum of the light, the spectrum having non-zero components at the at least two wavelengths, after the light has interacted with the sample; and
at least one layer arranged between the sample and the optical detector unit;
   wherein the at least one layer is at least partially optically transparent to the detected spectrum of the light; and
   wherein the at least one layer is sufficiently resistant to the harsh environment, to avoid that the harsh environment impair the optical detector unit.

By having a plurality of detector elements each at different wavelength regions, it is possible to obtain a fingerprint of the spectrum instead of the entire spectrum, so that processing the data or transmitting the data can be more lightweight, which is handy for embedded processing or remote processing in the cloud. In other words, the optical detector unit comprises a plurality of (optionally filtered) detector elements, which together may be sensitive to a wider wavelength range, for example the full NIR (near-infrared) spectral range. By limiting the number of detector elements, for example to sixteen detector channels, the spectral sensor system can advantageously be used for real-time measurements. For a higher number of detector elements, the obtained spectral fingerprint may contain significantly more data, which may increase the processing time.

By having the at least one layer arranged between the sample and the optical detector unit, it is possible to use the spectral sensor system with samples in harsh environments, e.g. for liquids, or with samples under high pressures and/or high temperatures, or in corrosive or acidic or vibrating environments. Besides that, this separation of the sample and the optical detector unit allows to have a fully non-contact operation, which is useful to avoid contamination of the optical detector unit by decontaminants, e.g. water or other liquids, or dust, and it also minimizes the effect of vibration to both the optical detector unit and the illumination unit.

Purely as an example, if the environment in which the sample is situated is humid or wet and is thus harsh in the sense that it contains moisture, the at least one layer may be made sufficiently resistant to that harsh environment by having a low permeability coefficient.

Purely as another example, if the environment in which the sample is situated is at a significantly higher pressure than the environment in which the optical detector unit is or should be kept, and is thus harsh in the sense that it has a high pressure, the at least one layer may be made sufficiently resistant to that harsh environment by having a high resistance to deformation under load, e.g. by being made of a sufficiently sturdy material and by having a sufficiently wide thickness.

Of course, environments may be characterized by multiple harsh elements, e.g. by being both wet and at high pressure, in which case the at least one layer may be sufficiently resistant to the multiple harsh elements.

Other examples of harsh environments may include hot, acidic, salty, corrosive, and/or vibrating environments. Examples of harsh environments may for example include the washing chamber of a laundry machine or washing machine, a coffee machine, a brewery installation, an oil refinery, or even more mundane examples such as trouser pockets.

By ensuring that the optical detector unit is configured for detecting a spectrum of the light, the spectrum having non-zero components at the at least two wavelengths, it is possible that the spectral sensor system is multi-channel or even broadband, and is therefore able to recognize several distinct material types. This would be impossible if just one wavelength were to be used.

Note that a spectrum of the light may contain one or more non-zero regions of the entire infinite spectrum.

In an embodiment, the at least two wavelengths are in the near-infrared spectrum of light.

In this way, a spectral region may be chosen in which various samples show diverse optical responses, which enables their classification.

In an embodiment, the at least two wavelengths are in the near-infrared and/or infrared and/or visible spectrum of light.

In this way, accuracy of classification may be further improved.

In an embodiment, the harsh environment is characterized by being so humid, hot, pressurized, acidic and/or corrosive, that contact of the harsh environment with the optical detector unit would impair the optical detector unit by damaging the optical detector unit or by hindering operation of the optical detector unit.

In an embodiment, the at least one layer has a permeability coefficient to fluids of less than 10⁻¹² cm².

The skilled person will appreciate that the permeability coefficient may depend on the fluid velocity, the applied pressure difference, the dynamic viscosity of the fluid and the thickness of the layer.

In this way, contamination of the optical detector unit by fluids (i.e. liquids and/or gases) can be avoided, since the layer material is impervious for these specifications.

In an embodiment, the at least one layer is configured to provide protection against ingress of dust and fluids following the specifications of the international IP41 standard.

In an embodiment, the at least one layer is configured to provide protection against impact following the specifications of the international IK00 standard.

In an embodiment, the at least one layer should be composed of a material that is chemically inert to the surrounding environment, i.e. not chemically reactive.

In this way, the system can be more resistant to the influences of the surrounding.

In an embodiment, the at least one layer is also arranged between the illumination unit and the sample.

In an embodiment, the at least one layer comprises a single layer, wherein the single layer is arranged between the sample and the optical detector unit, and wherein the single layer is arranged between the sample and the illumination unit.

In an alternative embodiment, the at least one layer comprises a first layer and a second layer, wherein the first layer is arranged between the sample and the optical detector unit, and wherein the second layer is arranged between the sample and the illumination unit.

In an example embodiment, the first layer and the second layer may be separated from each other, i.e. they may at a non-zero distance from each other. Preferably, the optical detector unit and the illumination unit may be facing opposite ends of the sample and the first layer and the second layer may be in line with the optical detector unit and the illumination unit respectively.

In an embodiment, the at least one layer is made of any one or more of the following materials: a polymer, such as polypropylene, polystyrene or high-density polyethylene, glass, quartz, or sapphire.

An advantage of the listed materials is that they are optically transparent to at least NIR light.

In an embodiment, the at least one layer comprises at least one stratified layer, wherein the strata of the stratified layer are made of at least two different materials.

In an embodiment, the illumination unit comprises at least one of the following: a broadband light source; a light emitting diode; and a series of lasers.

The broadband light source may be a lamp, for example a tungsten lamp.

In an embodiment, the illumination unit comprises at least one optical element configured for guiding the light to be emitted towards the sample.

The at least one optical element may e.g. be a lens, a filter, etc.

In an embodiment, the optical detector unit comprises at least one of the following:
a diffuser or non-imaging element configured for limiting spatial dependence from the sample;
an optical filter configured for limiting background radiation; and
an optical pupil configured for reducing the amount of light entering the optical detector unit.

In an embodiment, each detector element of the plurality of detector elements comprises a discrete pixel configured for detecting at least one wavelength region.

In an embodiment, each respective detector element of the plurality of detector elements comprises a detector area and a filtering element.

In an embodiment, the detector area of each respective detector element of the plurality of detector elements comprises an absorbing material that either is monolithically integrated with the filtering element or is combined with the filtering element.

In an embodiment, the spectral sensor system comprises a processing unit configured for determining at least one constituent material of the sample, based on the detected spectrum of the light.

The determining may for example be done using a database of known materials, in order to classify the detected spectrum of the light into suitable parameters, for example textile parameters (such as an identification of cotton, wool, linen, etc.) for a laundry machine application, or coffee parameters (such as roasting, type and origin, among others) for a coffee machine application.

In an embodiment, the spectral sensor system comprises a communication unit configured for transmitting the detected spectrum of the light to a processing server.

The processing server may be remote from the spectral sensor system and may comprise a processing unit configured for determining at least one constituent material of the sample, based on the detected spectrum of the light.

In an embodiment, the at least one layer has a thickness extending between the sample and the optical detector unit in a range between 1 mm and 20 cm.

The skilled person will appreciate that the exact thickness of the at least one layer may depend on the application, on the infrared penetration depth of any protective material used and on the luminance of the transmitted or reflected light signal.

In an embodiment, the spectral sensor system comprises a calibration unit configured for:
determining whether a physical condition of the at least one layer meets a deterioration threshold condition;
if it is determined that the physical condition of the at least one layer meets the deterioration threshold condition, sampling at least one calibration sample; and
recalibrating the spectral sensor system to take into account the physical condition of the at least one layer; and
if it is determined that the physical condition of the at least one layer meets the deterioration threshold condition, optionally triggering a maintenance procedure on the at least one layer.

A maintenance procedure may e.g. comprise cleaning, repairing, and/or restoring.

In an embodiment, the at least one layer is configured for collecting most of the radiation from the sample by acting as an additional macro lens.

In an embodiment, the at least one layer is configured for avoiding influence from the background of the environment.

In an embodiment, the optical detector unit is hermetically sealed by surface including at least part of the at least one layer.

In an embodiment, the at least one layer is at least in part defined by a pre-existing surface layer of a device, such that the spectral sensor system is retrofitted to the device.

In an embodiment, the spectral sensor system comprises a read-out electronic unit configured for converting the detected spectrum of the light into a digital form.

In an embodiment, the read-out electronic unit comprises an amplification stage, a demultiplexer, an analogue-to-digital converter, and a microprocessor.

There is provided in a second aspect according to the present disclosure a method of analysing a sample in a harsh environment; the method comprising:
emitting light to the sample at at least two wavelengths; and
using an optical detector unit according to any one of the previous claims, detecting a spectrum of the light, the spectrum having non-zero components at the at least two wavelengths, after the light has interacted with the sample;
   wherein at least one layer is arranged between the sample and the optical detector unit;
   wherein the at least one layer is at least partially optically transparent to the spectrum of the light; and
   wherein the at least one layer is sufficiently resistant to the harsh environment, to avoid that the harsh environment impair the optical detector unit.

The skilled person will understand that analogous considerations and advantages may apply to embodiments of the method as to above-described embodiments of the spectral sensor systems, mutatis mutandis.

In an embodiment, the method comprises determining at least one constituent material of the sample, based on the detected spectrum of the light.

The determining may for example be done using a database of known materials, in order to classify the detected spectrum of the light into suitable parameters, for example textile parameters (such as an identification of cotton, wool, linen, etc.) for a laundry machine application, or coffee parameters (such as roasting, type and origin, among others) for a coffee machine application.

In an embodiment, the method comprises transmitting the detected spectrum of the light to a processing server.

The processing server may be remote from the spectral sensor system and may comprise a processing unit configured for determining at least one constituent material of the sample, based on the detected spectrum of the light.

In a further developed embodiment, the method comprises controlling a machine based on the determined at least one constituent material of the sample.

### BRIEF DESCRIPTION OF THE DRAWINGS

The embodiments described above are merely intended to illustrate the present invention and are not intended to be interpreted in a limiting manner. The present disclosure will be more fully understood with the help of the description below and with reference to the appended drawings, in which:

FIG. 1 schematically illustrates an embodiment of a spectral sensor system according to the present disclosure;

FIG. 2 schematically illustrates an embodiment of a sensor module comprising a number of discrete pixels in a sensor array and the read-out electronic module;

FIG. 3 schematically illustrates the data flow of the fingerprint from the sensor module after data collection;

FIG. 4a schematically illustrates the embodiments according to the present disclosure of a spectral sensor system that can be used with one separation layer in between the sample material and the illumination and the detection unit according to the present disclosure;

FIG. 4b schematically illustrates the embodiments according to the present disclosure of a spectral sensor system that can also be used with multiple separation layers in between the sample material and the illumination and the detection unit according to the present disclosure;

FIG. 5a schematically illustrates an example of the positioning of a sensor system in a home appliances equipment. In this example a refrigerator;

FIG. 5b schematically illustrates an example of the positioning of a sensor system in a home appliances equipment. In this example a washing machine;

FIG. 5c schematically illustrates an example of the positioning of a sensor system in a home appliances equipment. In this example a coffee machine;

FIG. 5d schematically illustrates an example of the positioning of a sensor system in an industrial environment. In this example in a brewery system;

FIG. 6a shows examples of the normalized photocurrent averaged across multiple samples of four types of textiles;

FIG. 6 shows examples of the normalized reflectance averaged across multiple samples of four types of textiles;

FIG. 7a shows the confusion matrix for different textile types as follows from the classification model using the measured fingerprint; and

FIG. 7b shows the confusion matrix for different coffee types as follows from the classification model using the measured fingerprint.

### DETAILED DESCRIPTION

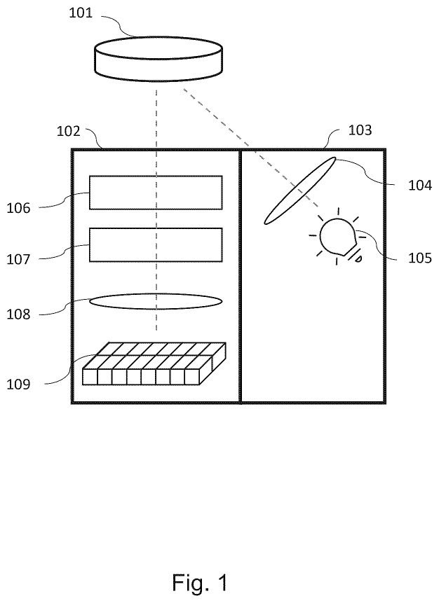

A spectral sensor system may comprise of an illumination unit and an optical detector unit (or shortened: detector unit) (see FIG. 1. Parts 102 and 103). The illumination unit has at least a light source e.g. a lamp (FIGS. 1, 105) and an optical element to ensure the optical emission of the light source to reach the sample area (indicated by FIGS. 1, 101). The light source has a broadband emission spectrum that covers the operation range of the detector element. The emitted light interacts with the sample and thereby generates corresponding reflected, transmitted, emitted and/or scattered light. The light after the optical interaction is collected using the detector unit (FIGS. 1, 102).

Note that transmitted light can be emitted by a light emitter, or can be the result of an optical interaction with a sample after originating from a light emitter. In other words, light can be transmitted from a light emitter, and light can also be transmitted from a sample after it has been transmitted from a light emitter and after it has interacted with the sample.

The detector unit can contain several components for manipulation of the collected light, e.g. by filtering or focusing the light. A diffuser or non-imaging element (FIGS. 1, 106) may be used to limit the spatial dependence from the sample objects, and thereby minimizes the difference between objects with the same chemical composition but different shapes. An optical filter (FIGS. 1, 107) can be employed to limit background radiation, for example visible light present in the measurement environment, making the system more robust in not-controlled environments. An optical pupil can be used to reduce the effect of environmental light and detect only the light that is originating from the sample. An optical element, e.g. a lens (FIGS. 1, 108) can be used to focus the interacted light onto the sensor element. The spectral sensor comprises an array of filtered detector elements, which together are sensitive to the full NIR spectral range. By limiting the number of detector elements, in this case to sixteen detector channels, the system can be used for real-time measurements. For a higher number of detectors, the obtained spectral fingerprint contains significantly more data which increases the process time.

The illumination unit and/or the optical detector unit may in some implementations comprise multiple spatially distanced parts. For example, the illumination unit may comprises multiple separate light sources arranged at a distance from each other, which has the advantage of more fully illuminating the sample. As another example, which may optionally be combined, the optical detector unit may comprise multiple separate detectors arranged at a distance from each other.

### Description Electronic Module

The sensor array comprises a number of discrete pixels. In the current implementation, each pixel is sensitive to one or multiple regions of the near infrared spectrum (from 850 to 1700 nm). Alternatively the sensor array can be sensitive also to other wavelength regions such as the visible or mid infrared region to further improve accuracy of the results.

Each pixel is composed of a detector area where light is absorbed and a filtering element. The filtering element and the detector can be realized on the same wafer via a monolithic approach or externally combined by heterogenous integration. Examples of absorbing material that can be used for the detectors are InGaAs, InGaAsP, PbSe, Germanium and Silicon. The filtering element can be realized using a dielectric material (silicon dioxide, titanium oxide, silicon nitride, amorphous silicon) and two mirrors composed either of metallic layers such as gold, silver or of Distributed Brag mirrors. In one implementation the detector is embedded in the filter structure to form a resonant cavity photodetector, which provides an enhanced sensitivity.

A broadband source is used to shine near-infrared light on an object. This source can be for example a tungsten lamp or a light emitting diode. The light is then guided though or reflected from a sample, and then focused on the sensor array. Each pixel will give a distinct response based on the input light spectrum from the object.

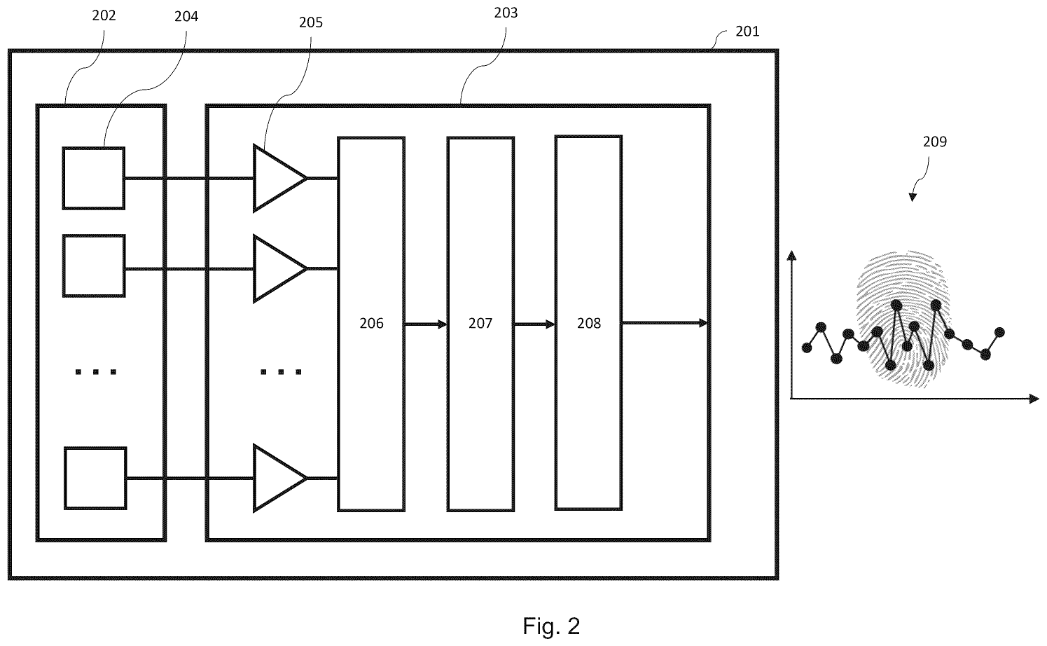

The integration time per pixel can be selected and can vary from a few milliseconds to a second. Each pixel converts a certain portion of the incoming light into an electrical photocurrent. Each pixel is then connected to a transimpedance amplifier stage that converts the current signal into a voltage. A demultiplexer stage selects each channel individually and sequentially and is connected to an Analog-to-digital (ADC) converter that transforms the analog signal into a digital number. A microprocessor interrogates the ADC and converts this into a suitable protocol, for example I2C. The read-out module is realized using either discrete elements or a single ASICS. The full sensor module comprises the sensor array and the read-out module (see FIG. 2). In the current implementation with 16 detectors, the output of the sensor module will consist in of a string of 16 numbers which represent the fingerprint of the material.

A spectral sensor system may comprise an illumination unit and an optical detector unit (or shortened: detector unit) (see FIG. 1. Parts 102 and 103). The optical detector unit may comprise a spectral sensor (which may also be called a detector array). This spectral sensor is illustrated in FIG. 2. In other words, the spectral sensor comprises an array of filtered detector elements, which together are sensitive to the full NIR spectral range.

### Description of Data Flow

The fingerprint from the sensor module can be delivered to a cloud, by transmitting these number via WIFI or cabled internet connection to an external dedicated server. Note that one of the advantages of a limited set of pixels instead of a full spectrum is the fact that this data stream is very limited with a reduction ×100 in storage and transmission time compared to a full near infrared spectrum which typically consists of few thousand data points. The cloud architecture includes calibration and prediction algorithms that transform the fingerprint into the results requested by the application. In the example of a washing machine, the output of the server will consist of a label indicating a certain textile type such as cotton, linen, silk, wool or mixture of them. In the case of a coffee machine the algorithm will determine the coffee type such as variety, roasting level and sensorial information.

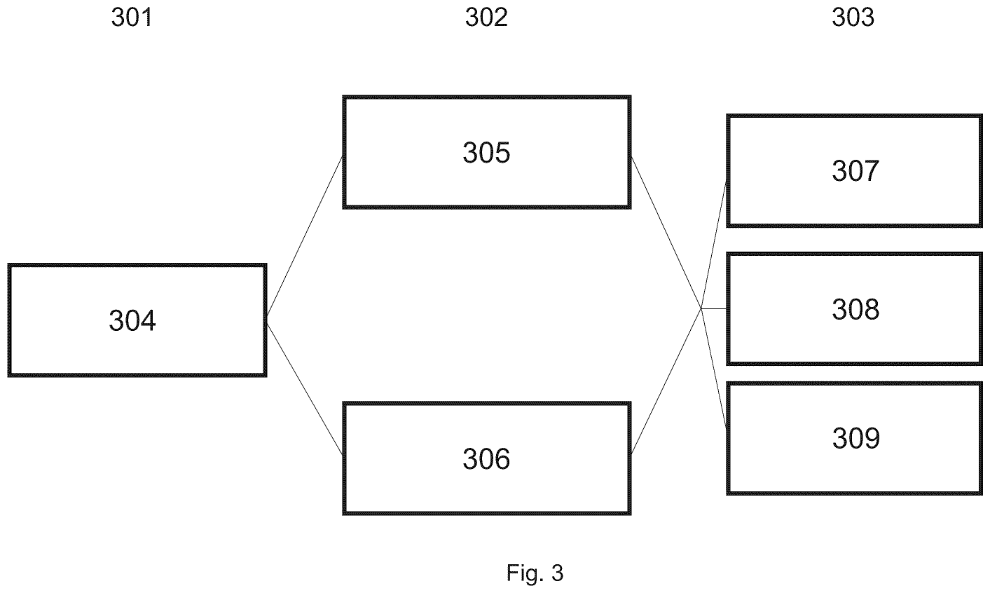

Alternatively, this computation can be performed locally inside the system by a local computer with a storage option, in particular if the solution does not need connectivity and speed is preferred. The output of the algorithm can be also a number and not only a class type. This is the case for example in the estimation of moisture level in coffee. Once the label or prediction number is computed either in the cloud or locally, this value can be transferred to an app for visualization and/or to a dashboard for logging or directly to the system for further control and to take further actions. This functionality can be used for example to select the best washing program in a washing machine or to set the best operation conditions such as temperature, pressure and timing in coffee machines. In the case of a refrigerator for example, this analysis can be used to inform the consumer regarding the freshness of products inside and to change the storing conditions. The described data flow is illustrated in FIG. 3.

### Protective Layers

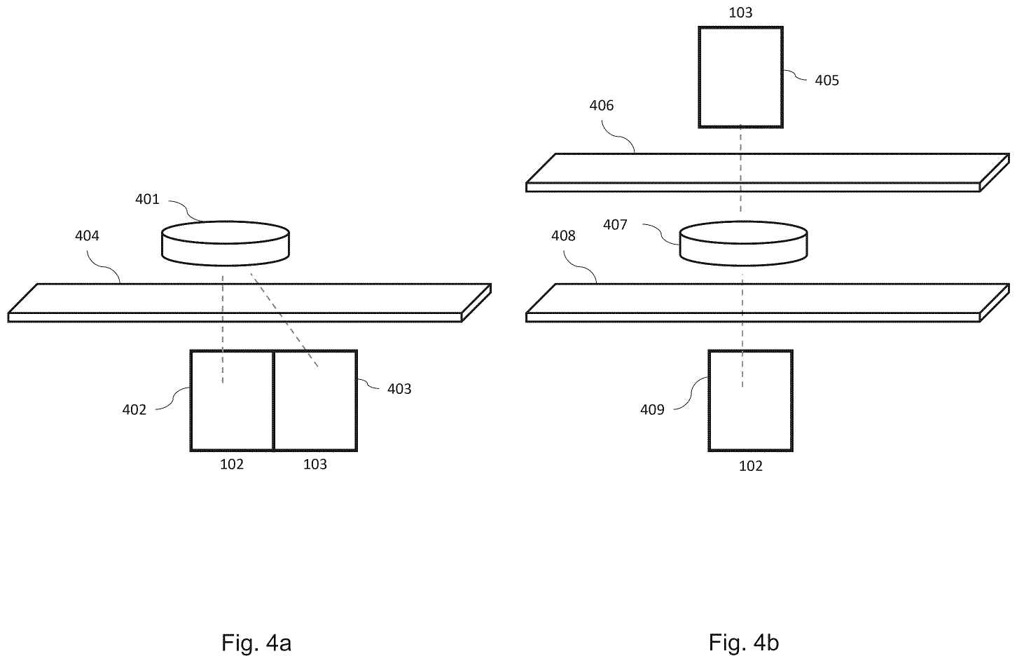

To use the sensing system for in-line solutions it is often required to physically separate the sensing and illumination module from the measured sample material. The solution presented by embodiments according to the present disclosure relates to a sensing system that can also be used with one or more separation layer(s) in between the sample material and the illumination and the detection unit. FIG. 4 shows this for the reflection configuration where both the detection and illumination units are on the same side (FIG. 4a) and the transmission configuration (FIG. 4b) where the illumination light is going through the sample material e.g. in the case of liquids or other type of (semi-)transparent materials. The separation layers are indicated by elements 404, 406 and 408. The separation layer should be optically transparent for the NIR light. This solution allows the use of the spectral sensor system in harsh environments, e.g. for liquids or the sensing of materials under high pressures and/or high temperatures. Besides that, this separation allows to have a full non-contact operation, which is essential to avoid contamination of the sensor by water or other liquids, it also minimizes the effect of vibration to both the detector unit and the illumination unit. The distance between the sample and the detector and illuminator unit can vary from zero to up to a meter. An auto-training routine can be implemented to take into account the various condition of the protective separation layers. In case of deterioration of the protective layers or change on its surface, the calibration model of the sensor can be retrained using calibration samples. Besides that, the combination of the detector and illumination unit can be used to analyse the current status of the protective surface and eventually trigger autocleaning procedures to bring the status of the system back to a known value. Examples of protective separation layers can be polymers (polypropylene, polystyrene, HDPE), standard glass, fused silica, quarts or sapphire windows. For specific applications also other protective layer materials can be used such as Silicon (Si) and Germanium (Ge) providing good NIR transparency and high mechanical tensile, elastic and fracture moduli, or Calcium Fluoride (CaF2), Barium Fluoride (BaF2) or Zinc Selenide (ZnSe) if very thick layers with very high NIR transmission are required. Each protective layer can have a given and a well-defined fingerprint in the spectral operation range of the detector array given by the absorption, reflection and scattering of the material of the protective layers. However this contribution is taken into account in the machine learning model realization and the model is realized already with a given surface condition. Also, the geometric shape of the protective layer is arbitrary and it can be flat or curved. However, the protective layer can be designed to collect most of the radiation from the sample under analysis acting as an additional macro lens or to avoid influence from environmental background. The various chambers can be separated hermetically or optionally be open. The thickness of the protective layers can vary from a few millimetres to few centimetres.

The protection layer can be in contact with the sample and the detector unit or separated by air. One key aspect of the protection layer is to have low permeability coefficient to liquid and/or gases. This enables the physical separation of the sample from the detector unit in order to avoid any possible contamination by powders, solids, liquids and gases. Besides that, the protection layer can be used to install the detector unit in existing equipment by choosing an existing layer which is in contact with the sample and making the solution retro compatible with existing equipment.

The position of the detector unit and illumination unit can be adjusted to take into account the additional presence of the protective surfaces.

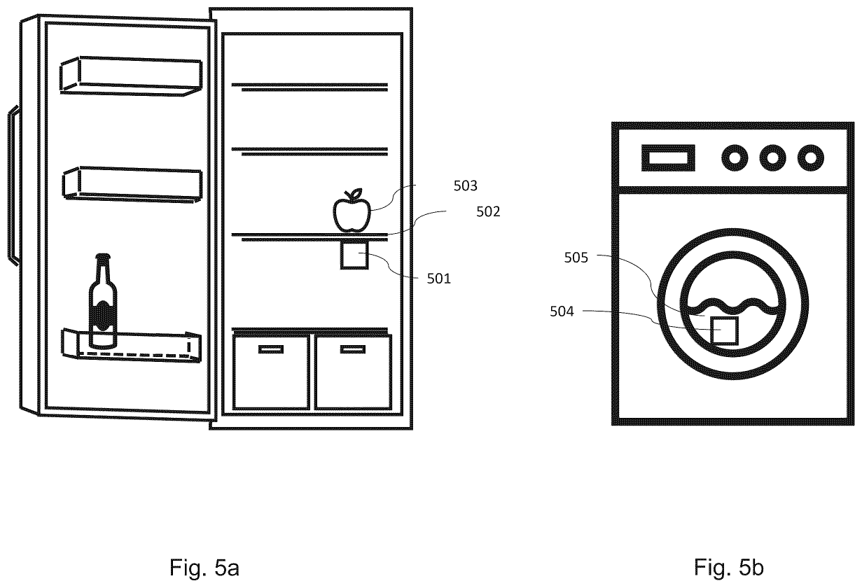

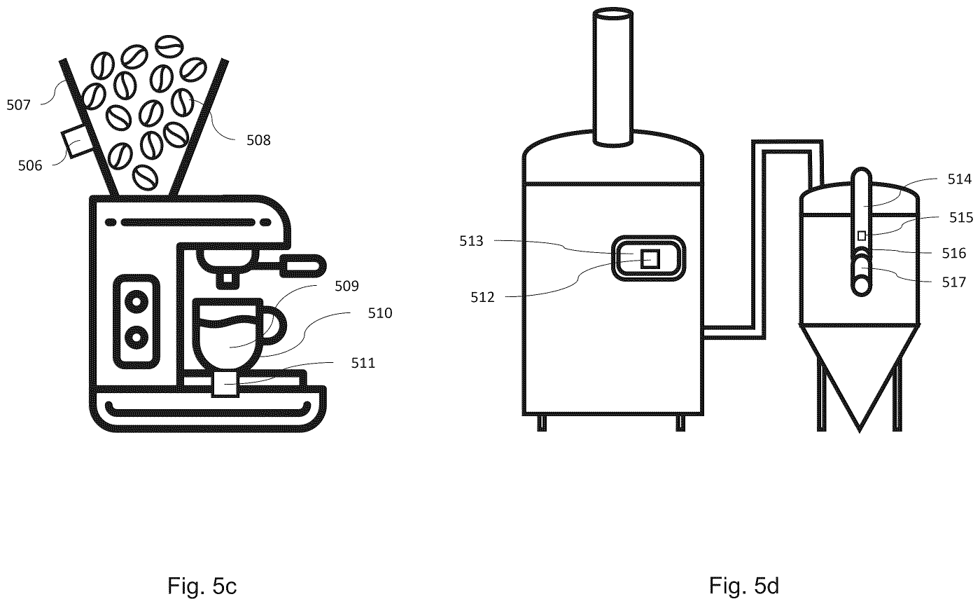

FIG. 5 shows a few examples of possible locations of the detector unit in a number of equipment found in home appliances such as refrigerator, washing machine, and a coffee machine. For example in the case of a refrigerator, the spectral sensor system (501) can be positioned below one shelf, the shelf acts as protective layer (502) in order to estimate the freshness of food (the sample, 503). For example, in a washing machine, the sensor (504) can be positioned behind the door (505) or any static glass surface, the washing mashing window acts as protective layer (505) and clothes can be analysed and their content predicted to select the best washing program automatically or in the case of a dryer to stop the drying process in time. In the case of a coffee machine, the container of the beans acts as protective layer (506), and the sensor (506) can be positioned in proximity of the container in order to estimate the quality and origin of the beans (the sample, 508). Additionally, the sensor can be positioned below the cup of coffee (511), the cup acting as protective layer (510), in order to estimate quality after brewing, which might be essential to get real-time control on the machine parameters (time, pressure, temperature) (the sample, 509). All these application examples show easy installation in home appliances. However, embodiments according to the present disclosure can find applications in industrial environments as well, such as in the food and drink industry. For example in the case of brewery, the sensor system (512) can be positioned on an optical window (513 protective layer) present on the container providing information on the inner liquid on a surface layer determined by the penetration depth of the light. Alternatively the detector (515) and illumination unit (517) can both be positioned inside a fiber (514) and the optical window of the fiber (516) being the protective layer. The latter configuration allows for measuring at arbitrary distance inside the container and having information deeper inside the liquid.

### Model-Building and Prediction Algorithms

The sensing system can be applied to application cases that fall into either the regression or classification category. The method of addressing both regression and classification problems are similar, and they both involve defining the sensing problem at hand, collecting and measuring samples and finally the model building and validation. In the problem definition stage, it is important to identify the parameter(s) that is intended to be measured, e.g. the roasting level and type of coffee beans or the protein content in milk. Within the second stage of ‘collecting and measuring samples’, reference data need to be obtained because the modelling process is based on building a correlation between sensor fingerprints and the reference parameter from an external, independent measurement. In the coffee example, the reference parameters may be available from the label on the product package. However, for other cases such as protein in milk, a separate reference measurement may be required to obtain the reference protein content. Depending on the specific application case, it may be beneficial to: (i) measure multiple points on a sample to account for variations within the sample and (ii) use a suitable illumination and measurement configuration, e.g. transmission, reflection or a custom geometry to optimize the signal to noise ratio. The third stage involves building a machine learning model to eventually predict the parameter of interest directly from sensor measurements. A subset of the measured samples designated to be the ‘training set’ may be used to train and optimize the classification or regression algorithms (including e.g. principal components analysis, partial least squares analysis, support vector machine, linear discriminant analysis, random forest, neural networks). To avoid overfitting, a cross-validation procedure should be followed in the model training process. Following the training process, the model can be validated using another subset of the measured samples designated as the ‘test set’. The test set be excluded in the model-training and can be used as a proxy to estimate the prediction performance of the model on new, unseen data.

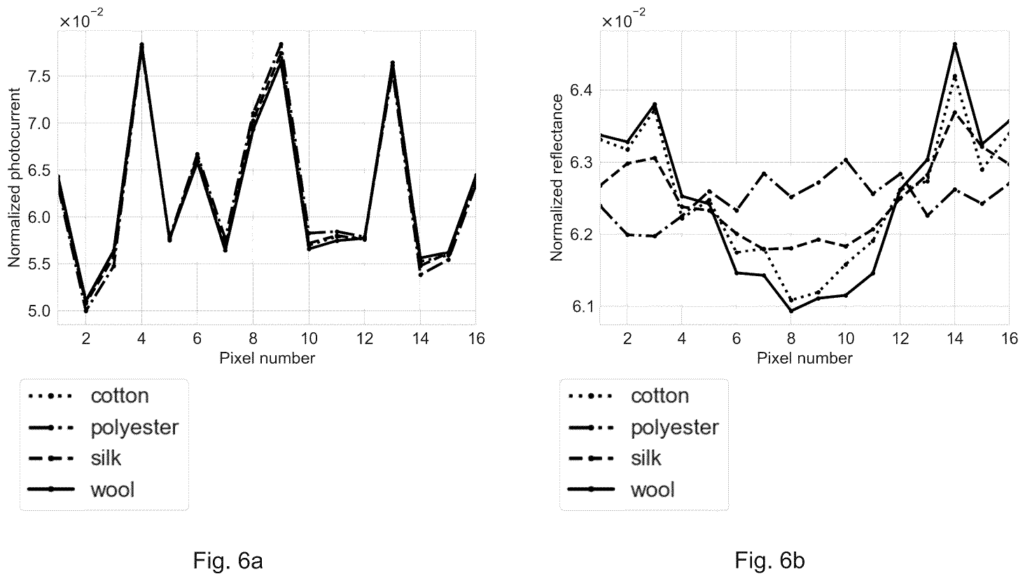

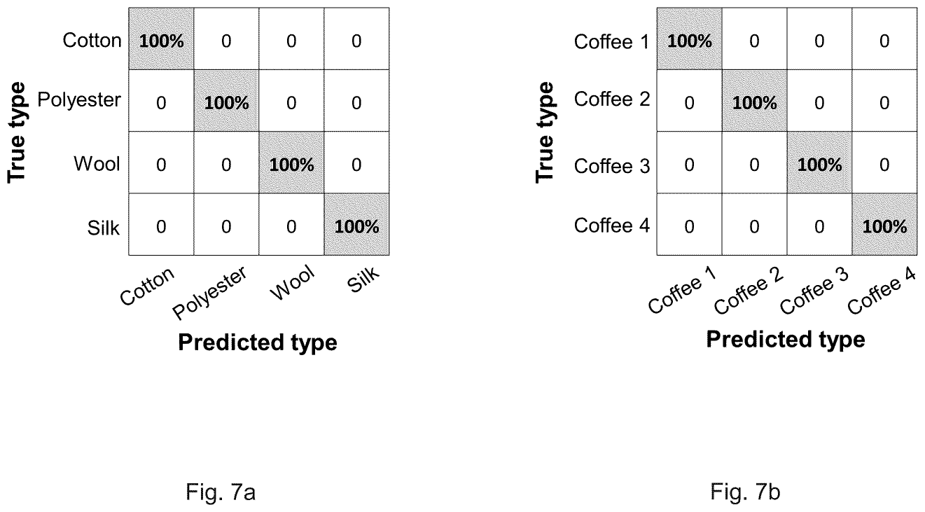

Classifying the types of textiles and coffee are examples of where the described concept can be applied. In the first example, the sensor measured a number of textile samples made of cotton, polyester, wool or silk through the separation layer. The measured fingerprints were used to build a classification model that resulted in 100% classification of the textile type, as presented in the confusion matrix (FIG. 7a). FIG. 6 shows examples of the normalized photocurrent (FIG. 6a) and normalized reflectance (FIG. 6b) averaged across multiple samples of four types of textiles. In both plots there are visible differences between the fingerprint of each textile type, and the difference is enhanced after conversion from photocurrent to reflectance.

In the second example of coffee type classification, the sensor measured 4 types of grounded coffee of different roasting levels and origin through a separation layer. The classification model built using the measured fingerprints also obtained a 100% accuracy of the coffee type, presented in the second confusion matrix (FIG. 7b).

### LIST OF ELEMENTS

FIG. 1
101: sample
102: detector unit
103: illumination unit
104: optical element
105: light source
106: diffuser
107: optical filter
108: lens
109: sensor element
FIG. 2
201: sensor module
202: sensor array
203: read-out electronic module (REM)
204: pixel
205: transimpedance amplifier
206: DEMUX
207: ADC
208: uC
209: spectral fingerprint illustration
FIG. 3
301: phase 1: data collection
302: phase 2: analysis
303: phase 3: visualization and control
304: sensor module
305: cloud
306: on board processor
307: system control
308: mobile app
309: web dashboard control
FIG. 4
401: sample
402: detector unit
403: illumination unit
404: layer
405: illumination unit
406: layer
407: sample
408: layer
409: detector unit
FIG. 5
501: spectral sensor system
502: layer
503: sample
504: spectral sensor system
505: layer
506: spectral sensor system
507: layer
508: sample
509: sample
510: layer
511: spectral sensor system
512: spectral sensor system
513: layer
514: fiber
515: detector
516: layer
517: illumination unit
FIG. 6
Graph
FIG. 7
Matrix

In the matrix of FIG. 7, as an example “Coffee 1” refers to an Arabica, blonde roast; “Coffee 2” to an Arabica, medium roast; “Coffee 3” to a decaffeinated Arabica, dark roast; and “Coffee 4” to a decaffeinated Arabica and Robusta, dark roast.

1. A spectral sensor system for analysing a sample in a harsh environment, the system comprising:
an illumination unit configured for emitting light to the sample at at least two wavelengths;
an optical detector unit comprising a plurality of detector elements, wherein each respective detector element of the plurality of detector elements is configured for detecting one or more respectively different wavelength regions, wherein the optical detector unit is configured for detecting a spectrum of the light, the spectrum having non-zero components at the at least two wavelengths, after the light has interacted with the sample; and
at least one layer arranged between the sample and the optical detector unit;
wherein the at least one layer is at least partially optically transparent to the detected spectrum of the light; and
wherein the at least one layer is sufficiently resistant to the harsh environment, to avoid that the harsh environment impair the optical detector unit.

2. The spectral sensor system of claim 1, wherein the at least two wavelengths are in the near-infrared spectrum of light.

3. (canceled)

4. The spectral sensor system of claim 1, wherein the harsh environment is characterized by being so humid, hot, pressurized, acidic and/or corrosive, that contact of the harsh environment with the optical detector unit would impair the optical detector unit by damaging the optical detector unit or by hindering operation of the optical detector unit.

5. The spectral sensor system of claim 1, wherein the at least one layer has a permeability coefficient to fluids of less than 10-12 cm2.

6. The spectral sensor system of claim 1, wherein the at least one layer is configured to provide protection against ingress of dust and fluids following the specifications of the international IP41 standard.

7. The spectral sensor system of claim 1, wherein the at least one layer is configured to provide protection against impact following the specifications of the international IK00 standard.

8. The spectral sensor system of claim 1, wherein the at least one layer is composed of a material that is chemically inert to the surrounding environment.

9. The spectral sensor system of claim 1, wherein the at least one layer is also arranged between the illumination unit and the sample.

10. The spectral sensor system of claim 9,
wherein the at least one layer comprises a single layer, wherein the single layer is arranged between the sample and the optical detector unit, and wherein the single layer is arranged between the sample and the illumination unit; or
wherein the at least one layer comprises a first layer and a second layer, wherein the first layer is arranged between the sample and the optical detector unit, and wherein the second layer is arranged between the sample and the illumination unit.

11. The spectral sensor system of claim 1, wherein the at least one layer is made of any one or more of the following materials: a polymer, such as polypropylene, polystyrene or high-density polyethylene, glass, quartz, sapphire, silicon, germanium or very high NIR transmission compounds.

12. The spectral sensor system of claim 1, wherein the at least one layer comprises at least one stratified layer, wherein the strata of the stratified layer are made of at least two different materials.

13. (canceled)

14. (canceled)

15. (canceled)

16. (canceled)

17. (canceled)

18. (canceled)

19. (canceled)

20. (canceled)

21. The spectral sensor system of claim 1, wherein the at least one layer has a thickness extending between the sample and the optical detector unit in a range between 1 mm and 20 cm.

22. The spectral sensor system of claim 1, comprising a calibration unit configured for:
determining whether a physical condition of the at least one layer meets a deterioration threshold condition;
if it is determined that the physical condition of the at least one layer meets the deterioration threshold condition, sampling at least one calibration sample; and
recalibrating the spectral sensor system to take into account the physical condition of the at least one layer; and
if it is determined that the physical condition of the at least one layer meets the deterioration threshold condition, optionally triggering a maintenance procedure on the at least one layer.

23. The spectral sensor system of claim 1, wherein the at least one layer is configured for collecting most of the radiation from the sample by acting as an additional macro lens.

24. The spectral sensor system of claim 1, wherein the at least one layer is configured for avoiding influence from the background of the environment.

25. (canceled)

26. The spectral sensor system of claim 1, wherein the at least one layer is at least in part defined by a pre-existing surface layer of a device, such that the spectral sensor system is retrofitted to the device.

27. (canceled)

28. (canceled)

29. A method of analysing a sample in a harsh environment; the method comprising:
emitting light to the sample at, at least two wavelengths; and
using an optical detector unit according to any one of the previous claims, detecting a spectrum of the light, the spectrum having non-zero components at the at least two wavelengths, after the light has interacted with the sample;
wherein at least one layer is arranged between the sample and the optical detector unit;
wherein the at least one layer is at least partially optically transparent to the spectrum of the light; and
wherein the at least one layer is sufficiently resistant to the harsh environment, to avoid that the harsh environment impair the optical detector unit.

30. The method of claim 29, comprising determining at least one constituent material of the sample, based on the detected spectrum of the light.

31. The method of claim 29, comprising transmitting the detected spectrum of the light to a processing server.

32. The method of claim 31, comprising controlling a machine based on the determined at least one constituent material of the sample.
